(19) United States
(12) Patent Application Publication
(10) Pub. No.: US 2017/0024833 A1
(43) Pub. Date: Jan. 26, 2017

(54) RK Construction Process Patent

(71) Applicant: Ram Menachem Katave, Richardson, TX (US)

(72) Inventor: Ram Menachem Katave, Richardson, TX (US)

(21) Appl. No.: 14/699,439

(22) Filed: Jul. 20, 2015

(51) Int. Cl. G06Q 50/08; G06Q 10/10

(52) U.S. Cl. CPC G06Q 50/08; G06Q 10/103

(57) ABSTRACT

This specific construction technique allows specified construction needs as stated in the contract with the developer to be met more effectively than traditional construction techniques. The present invention discloses a system and method for construction work fulfilled by the construction companies on behalf of a customer or developer. This construction process allows the construction company to better manage construction. The RK Construction Process, which is more efficient than “conventional” construction processes found in prior construction companies, specifies construction needs as stated in the contract between the contractor and the developer. The conventional construction process is the direct hiring of an hourly worker, while this process is the science of hiring a tradesman by contract until construction completion. The RK Construction Process Patent improves construction capabilities and limits the liability of loss of any given casualty or on site injury.

### REFERENCE TO RELATED APPLICATIONS

This application claims benefit to Provisional Application 61/988,209, filed May 4, 2014.

### STATEMENT REGARDING FEDERAL SPONSORED RESEARCH OR DEVELOPMENT

Not Applicable

### REFERENCE TO SEQUENCE LISTING, ETC.

Not Applicable

### BACKGROUND OF THE INVENTION

This invention relates to construction management (hereinafter referred to as “RK Construction Process Patent”) or otherwise known as contractors.

The art of construction management has become increasingly popular in recent history. Construction management involves at least two of three parties; each bilaterally agrees to perform certain duties as a result of work performance. The object of construction management is to apply or install a specific trade onto a construction project. As construction needs increase, so has advancement in construction management.

Currently most construction companies use a conventional construction process for hiring the construction workers using direct means. The vast majority of construction companies now use contracts to increase performance.

In addition to increases in efficiencies related to construction management, construction companies are also looking to increase the number of workers they have available without the need to hire more specialized contractors. This has led to a dizzying array of construction companies (hereinafter referred to as “contractors”) such as in the Engineer New Record 400 who employ companies to perform functions on the construction project up until completion. The contractors allow a customer to greatly increase the number of construction workers available without ascertaining prior experience, which can be hazardous to construction workers in task. In correlation with subcontractors, these contractors have the requirement of needing subcontractors that have a certain prior performance guarantee. Unlike a traditional construction company, however, these contractors commonly use specialty contractors. It is the intersection of the sub contractor process found in company structure and the contractors found performing interchangeable supervisory tasks, which gave rise to the present invention.

The present construction management process relates to an improved way to manage construction from a customer to a contractor or construction business. Construction management has dramatically increased with improvement in demand and increasingly high end construction projects. The methods include customer, contractors, and hired workers; one or more of which are disclosed by Katave in U.S. Provisional Pat. No. 61/988,209. In existing developers and contractors, there is a delay from the time the construction project begins in the approval process of determining the end results of the materials application or installation. Specialized contractors or Sub-contractors may perform this sample determination in order to verify the pricing will be performed within the scope of work expressly agreed upon in the customer contract. The subcontractor then bridges the gap of expectations by signing a contract for the labor to be performed at a specific price. This gap in contractual performance becomes fulfilled with less liability and more expertise than traditional construction process methods of directly hiring labor until completion by salary. The conventional construction management structure is hindered by a non goal oriented business structure and a tendency for liability concerns. Since the subcontractor's oversight of the specialized contractor is a limiting factor in the direct relationship with hired workers, there is an improvement in the liability, and oversight, between the subcontractor and customer with increase in construction performance.

### BACKGROUND OF THE INVENTION

The present invention preserves the construction management operation of prior art construction management systems but can provide significant increases, via procedural design, in oversight, and liability of customer and Construction Company in comparison to prior art systems. By using the subcontractor system between Construction Company and developer, the present invention significantly reduces the liability which the customer undertakes in direct responsibility to the hired workers and thus, the need for greater exposure to casualties on the jobsite. The weaknesses for liability suits are eliminated with the elimination of the conventional construction process. While the hired workers execution of subcontractor duties may be misconstrued as direct representation, the special performance contracts between all three parties (customer, subcontractor, and specialized contractor) presuppose the goodwill of the customer; initial preparation efforts required by the contractors and set up the subcontractor in a zero sum gain. Unlike prior art devices, this invention allows the construction company to replace labor onsite by request of a customer; therefore, the subcontractor participates in oversight virtually instantaneously.

Specialized worker performance contracts between contractors is achieved by a customer contract, subcontractor change order request, or addendums to both new and upcoming projects via direct attachment to an online bidding process or otherwise software program (ex. Isqft).

An object of the present invention to provide a process and system of construction management advances to initiate the construction process execution sequence on behalf of a customer.

It is a further object of the present invention to provide an alternative specialized contractor for the specialized contract fulfillment of a trade application or installation to control construction performance. These and other features, aspects and advantages of the present invention will become better understood with reference to the following description, appended claims and accompanying drawing.

### BRIEF DESCRIPTION OF THE DRAWINGS

FIG. 1: Illustrates the construction process of the invention

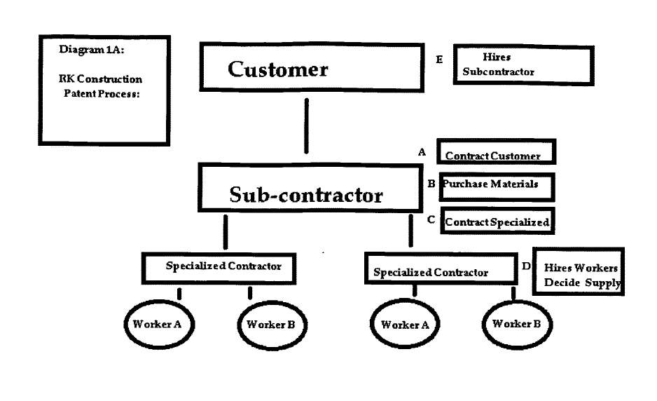

### DESCRIPTION

This invention provides a means for construction between the customer (“developer”) in a construction project and construction company (“contractor”). The construction guidelines between the customer and construction company may include handwritten, email, or fax means.

In well known and common contractors, an ongoing labor force resides within the contractor's trade specialty. This construction relationship contract includes labor and material costs, adjusts and determines updated price adjustments as necessary, and sends a final contract. This construction agreement accepts customer and contractor negotiations, alters and includes alterations as necessary and sends construction company representatives to control the specialized contractors' construction sequence.

The preferred embodiment of the present invention provides for an additional output from the customers construction contractual agreement(s). This additional output may be leveraged through retainer or bond by a customer's contractual obligations. In the circumstance where the customer or subcontractor resides outside of the said construction site's state, the contractor will likely use a local specialized contractor's license to represent execution of construction contract obligations.

In well known and common construction companies, a hired work force resides within the company. This hired work force accepts construction requests on an hourly basis from their business owners or customers, and sets up an executor process to fit the customer's construction need. The output from the hired workers causes an application or installation of construction work. The contractor is directly not indirectly connected to hired workers which apply or install the contractor's assignment.

The output from the customer enables the contractor to progress. The phase evaluation is directly or indirectly connected to the release of payments by the customer directly to the contractor. The preferred embodiment of the present invention allows for additional specialized contractors to perform subcontractor tasks. Additional specialized contractors may either replace hired workers used in prior work currently on site or to expedite the customers' needs.

The additional specialized contractor will exist as a medium for hired worker execution. In the circumstance in which the contractor resides outside of the construction location's primary state, the contractor or specialized contractors will likely utilize existing sub-specialty contractor licenses on the state's contractor's licensing board.

The contract between the contractor and specialized contractor must first establish a sale price for work performed per square foot to prevent unintended loss from other hired workers. After this common agreement is established, the specialized contractor organized the labor to the construction site before, during, or after the first construction day. The specialized contractor's trade execution may be started, aborted, or repeated at any point throughout the construction life cycle. In the preferred embodiment, the specialty contractor will execute the construction approximately entirely without supervision.

Once the specialized contractor's contract executes through each construction phase, the customer releases a payment that is processed onto the specialized contractor via the contractor. If the specialized contractor chooses to accept and process the contractor's construction agreement from the customer, the specialized contractor on assignment will directly or indirectly manage most oversight tasks associated with trade completion. At this point, the prior art construction management sequence resumes as the contractor proceeds to hire workers directly to feed the execution of their special trade's application or installation. After receipt of the hired workers weekly hours, the customer could, but not necessarily need to, process payment to the hired workers to acknowledge payment for hours of service rendered to acknowledge receipt of execution of service provided. The utilization of the preferred embodiment of the present invention eliminates the need for “conventional” construction management concerns between the customer and the skilled laborers.

Even though the present invention has not been described in considerable detail with reference to certain preferred versions thereof, other versions are possible. Therefore, the spirit and scope of the appended claims should not be limited to the description of the preferred version contained herein.

What is claimed is:

1. A general contractor process comprising: a) developer or customer (“purchaser”) with a construction company or (“seller” or “self”), a subordinate construction company to provide labor, said developer including a construction phase completion evaluation; b) A general contractor process (“construction company”) who has signed a contract for work performance with the developer, said construction company having a written agreement with the developer but not otherwise signed construction agreements with specialized contractors in accordance with the work expressly written in the contract, said contractor further having a assigned construction company; c) A means with which can coordinate an expressly written contract to verify work performance until completion; d) The Sub Contractor performs the work assigned by directly hiring workers and by purchasing materials on behalf of a sub-contractor. The contract signed by the general contractor with the specialized contractor, which the sub-contractor may act upon, and cause specialized workers to apply materials on the construction site, said means including oversight in said specialized work that, when said subcontractor receives construction permission, sends a specialized contractor to said construction site reflecting at least one or more of “hired workers” to begin the application or installation of the construction need as specified in the contract between the developer and the subcontractor. General contractor having said supervisory rights to evaluate work at each phase turn over before processing payment to subcontractor. The construction applied by “hired workers” through the subcontractor agreement must reflect work only as expressly stated in the contract between the customer and the subcontractor, and to ignore any construction work that does not include contractual obligation. The construction supervised by “specialty trade contractors” through the contract agreement.

2. The process of claim 1 wherein the customer is property owner, developer, and/or general contractor.

3. The process of claim 1, wherein said output reflects at least one or more of the hired workers is desired by said customer as a result of previous work hired through the general contractor to the specialty trade contractor.

4. The process of claim 1, wherein said contract specialized between general contractor/customer to specialized contractor and said subcontractor are at least substantially identical in location for labor execution.

5. A construction system, comprising: a general contractor; subcontractors' by a specialized contractor; wherein said sub contractor's hired workers fulfill the contractual obligations on behalf of the sub-contractor said specialized contractor agrees to perform the labor in accordance with the scope of work as specified in contract with sub-contractor, said sub-contractor negotiates a contract for the price of construction directly with the specialty trade contractor who has been pre-selected on the basis of bidding to the specific task, wherein sub-contractor said purchases the materials; the specialized contractor performs the work and helps with material supervision in accordance with the specialized contract work to the general contractor. The general contractor then disburses payments after a phase evaluation with the specialty trade contractor.

6. The process of claim 5, wherein said specialized contractor purchases materials through the “sub-contractor”, said hired workers choose materials to complete construction and to ignore at least responsibility for purchase, said purchase will charge to the sub-contractor. The general contractor does not pay for materials or products installed by said sub-contractor on behalf of specialized trade contractor.

7. The process of claim 5, wherein said materials are pre-approved by subcontractor and customer, said materials will be expressly stated by contract with terms of obligations for purchase requirements.

8. The process of claim 5, wherein said hired workers through specialized contractor may be monitored by sub-contractor, said hired workers may not be given specific direction so as to protect subcontractor from employee liability. General contractor and specialized trade contractor supervise the construction process.

9. The process of claim 5, wherein one or more specialized trade contractors does not alter utility of said construction process in a specific industry.

10. The process of claim 5, wherein one or more hired workers is represented by an additional “specialized contractor”, said specialized contractor may directly hire workers on behalf of the specialized contractor that is hired by said general subcontractor.

11. The process of claim 5, wherein specialized contractors represent one or more construction site obligations made by general contractor to the customer. The construction site obligations are followed through with supervision by specialty trade contractor and general contractor with certain OSHA standards.

12. The process of claim 5, wherein said contract includes at least an estimate of a purchase by specialty trade contractors on behalf of the general contractor.

13. The process of claim 5, wherein reimbursement of additional construction services by general contractor to specialty contractor on behalf of sub-contractor may follow the construction process patent design terms in contradiction of architectural scope drawings.

14. The process of claim 5, wherein the entire process for operation of the construction process may be started, aborted, or repeated at any point throughout the construction life cycle.

15. The process of claim 5, wherein said specialized contractor A and said subcontractor B are at least substantially accountable to the general contractor through the specialized contractor in terms of work performance.

16. The process of claim 5, wherein said Sub Contractor B and said hired workers C are at least substantially identical in duties performed throughout the construction life cycle.

17. The process of claim 5, wherein said Worker C and said Worker D are at least substantially identical in duties performed throughout the construction life cycle.

16. The process of claim 5, wherein said specialized contractor A and said subcontractor B are at least substantially accountable to the general contractor through the specialized contractor in terms of work performance.

17. The process of claim 5, wherein said contractors include an additional contractor between said specialized contractors and hired workers does not alter this construction procedure.

18. The process of claim 11 wherein said operational process includes at contractual obligations for specific materials within general contractor's written execution of contractor construction performance agreement with customer and specialty trade contractor.

19. The process of claim 17, wherein said operational process includes at least an alteration to the final cost of the work performed by the specialty trade contractor or sub-contractor if expected work performed on site increases in service.

20. The process of claim 19, wherein the creation of the adjustment in price is considered a “change order” to the final cost of the work amount billed by the sub-contractor to the general contractor.
